(19) United States
(12) Patent Application Publication
(10) Pub. No.: US 2025/0026029 A1
(43) Pub. Date: Jan. 23, 2025

(54) ELEMENT PICKUP MECHANISM

(71) Applicants: GLOBAL UNICHIP CORPORATION, Hsinchu City (TW); TAIWAN SEMICONDUCTOR MANUFACTURING COMPANY, LTD., Hsinchu (TW)

(72) Inventors: Chih-Chieh LIAO, HSINCHU CITY (TW); Yu-Min SUN, HSINCHU CITY (TW); Chih-Feng CHENG, HSINCHU CITY (TW)

(21) Appl. No.: 18/464,253

(22) Filed: Sep. 10, 2023

(30) Foreign Application Priority Data
Jul. 18, 2023 (TW) 112126696

(51) Int. Cl. B25J 15/06

(52) U.S. Cl. CPC B25J 15/0616

(57) ABSTRACT

An element pickup mechanism includes a pick-up arm and an elastic gasket. The pick-up arm includes a bracket, an air-extraction pipe and a suction cup. The bracket is provided with an inner space and an opening that is formed on one side of the bracket and in communication with the inner space. The air-extraction pipe is disposed on the bracket and connected to a vacuum pump equipment. The suction cup is sleeved on one end of the air-extraction pipe, located in the inner space and faced towards the opening of the bracket. The elastic gasket includes a flexible pad and a through hole. The flexible pad is formed with a flat surface and an attached surface that is fixedly attached to the side of the bracket. The through hole penetrates through the flexible pad to coaxially align with the opening and the suction cup.

### RELATED APPLICATIONS

This application claims priority to Taiwan Application Serial Number 112126696, filed on Jul. 18, 2023, which is herein incorporated by reference in its entirety.

### BACKGROUND

### Field of Disclosure

The present disclosure relates to an element pickup mechanism. More particularly, the present disclosure relates to an element pickup mechanism capable of picking up a packaged chip with a coating layer thereon.

### Description of Related Art

Generally, when a semiconductor packaged chip is performed by an electrical test, a retrieval arm may be used to adsorb a top surface of the semiconductor packaged chip by vacuum suction, so that the semiconductor packaged chip can be moved to a corresponding electrical test.

However, if the top surface of the semiconductor packaged chip is formed with a porous structure, it will be difficult for the retrieval arm to grab the semiconductor packaged chip by vacuum suction, thereby increasing the risks that suction failure to the semiconductor packaged chip or falling damage during transportation.

Therefore, the above-mentioned technology apparently is still with inconvenience and defects and needed to be further develop. Hence, how to develop a solution to improve the foregoing deficiencies and inconvenience is an important issue that relevant persons engaged in the industry are currently unable to delay.

### SUMMARY

One aspect of the present disclosure is to provide an element pickup mechanism for solving the difficulties mentioned above in the prior art.

In one embodiment of the present disclosure, an element pickup mechanism includes a pick-up arm and an elastic gasket. The pick-up arm includes a bracket, an air-extraction pipe and a suction cup. The bracket is provided with an inner space and a first opening. The first opening is formed on one side of the bracket and in communication with the inner space. The air-extraction pipe is disposed on the bracket and used to connect to a vacuum pump equipment. The suction cup is sleeved on one end of the air-extraction pipe, located in the inner space and faced towards the first opening of the bracket. The elastic gasket includes a flexible pad and a through hole. The flexible pad is formed with a flat surface and an attached surface which are opposite to each other. The attached surface is fixedly attached to the one side of the bracket. The through hole penetrates through the flexible pad to coaxially align with the first opening and the suction cup. When the flat surface of the flexible pad directly covers a packaged chip and a suction nozzle of the suction cup covers the first opening, the air-extraction pipe sucks the packaged chip onto the flexible pad by vacuum pumping through the through hole.

In one embodiment of the present disclosure, an element pickup mechanism includes a flexible pad, a bracket and an air-extraction pipe. The flexible pad has a first surface and a second surface which are opposite to each other. The flexible pad is formed with a through hole penetrating through the flexible pad to be connected to the first surface and the second surface, and the first surface is used to press a packaged chip. The bracket is connected to the second surface of the flexible pad. The air-extraction pipe includes a pipe main body and a suction cup. The pipe main body is liftably passed through the bracket, and one end of the pipe main body is connected to a vacuum pump equipment, and another end of the pipe main body is sleeved on the suction cup, and an inner portion of the pipe main body is in communication with the through hole through the suction cup, so that the vacuum pump equipment is able to vacuum-adsorbed the packaged chip onto the flexible pad through the air-extraction pipe and the through hole.

Thus, through the construction of the embodiments above, the disclosure is able to improve the success rate of vacuum adsorption on packaged chips, thereby reducing the risks that suction failure to the semiconductor packaged chip or falling damage during transportation.

The above description is merely used for illustrating the problems to be resolved, the technical methods for resolving the problems and their efficacies, etc. The specific details of the present disclosure will be explained in the embodiments below and related drawings.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure.

FIG. 1 is a schematic view of an element pickup mechanism according to one embodiment of the present disclosure.

FIG. 2 is a disassembled view of the element pickup mechanism of FIG. 1.

FIG. 3A is a top view of the bracket of FIG. 2.

FIG. 3B is a bottom view of the bracket of FIG. 2.

FIG. 3C is a front view of the flat surface of the elastic gasket of FIG. 2.

FIG. 4A to FIG. 4D are continuous operation schematic views of the element pickup mechanism of FIG. 1.

FIG. 5 is a schematic view of an element pickup mechanism according to one embodiment of the present disclosure.

FIG. 6 is a schematic view of an element pickup mechanism according to one embodiment of the present disclosure.

### DESCRIPTION OF THE EMBODIMENTS

Reference will now be made in detail to the present embodiments of the present disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the present disclosure.

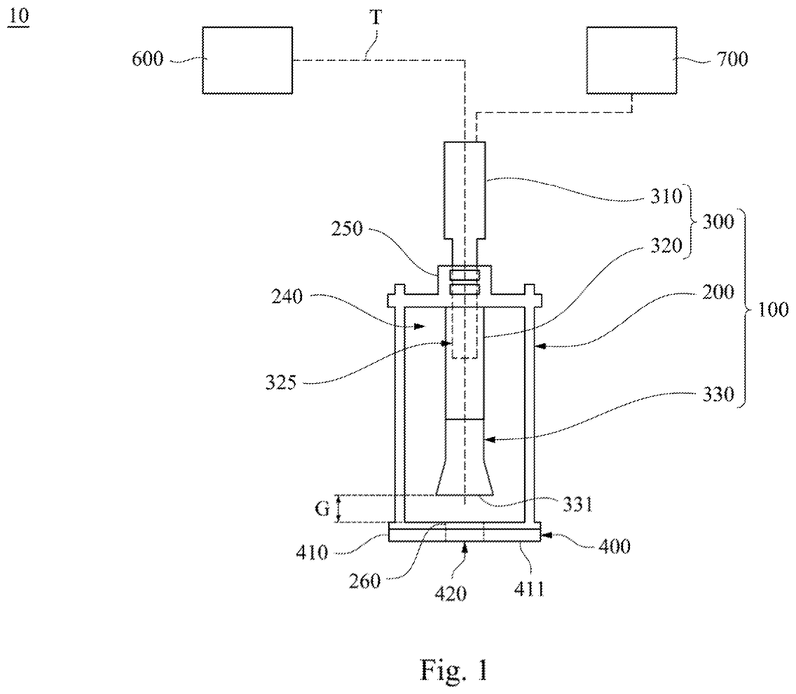

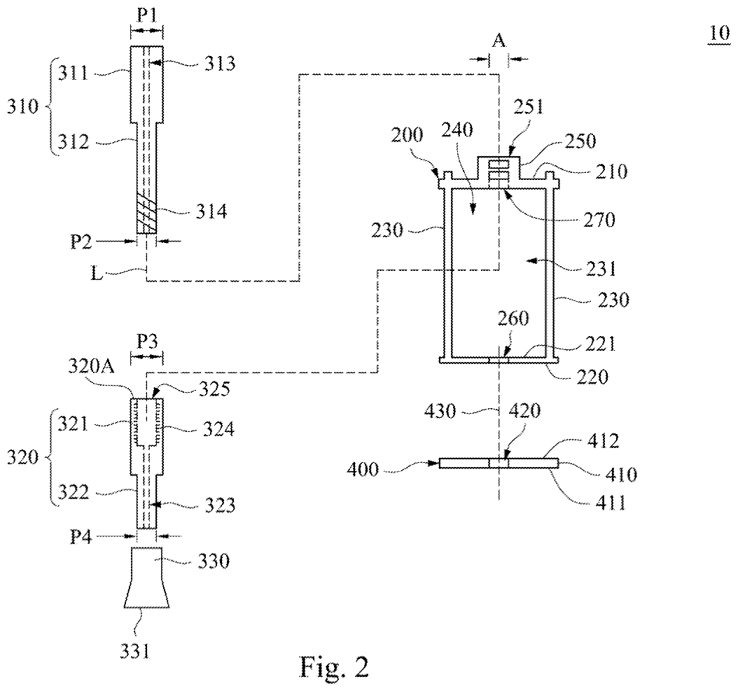

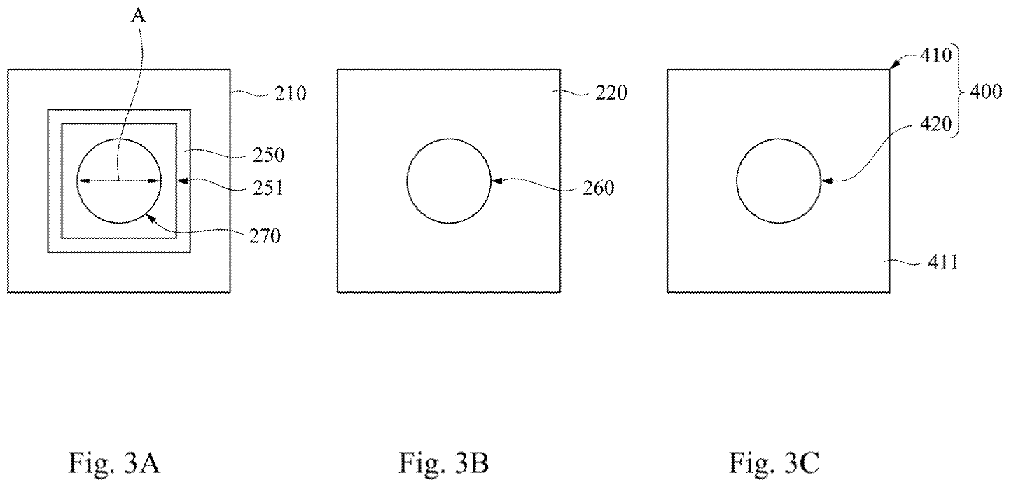

Reference is now made to FIG. 1 to FIG. 3C, in which FIG. 1 is a schematic view of an element pickup mechanism 10 according to one embodiment of the present disclosure. FIG. 2 is a disassembled view of the element pickup mechanism 10 of FIG. 1. FIG. 3A is a top view of the bracket of FIG. 2. FIG. 3B is a bottom view of the bracket 200 of FIG. 2. FIG. 3C is a front view of the flat surface 411 of the elastic gasket 400 of FIG. 2. As shown in FIG. 1 to FIG. 3C, in this embodiment, the element pickup mechanism 10 includes a pick-up arm 100 and an elastic gasket 400. The pick-up arm 100 includes a bracket 200, an air-extraction pipe 300 and a suction cup 330. The bracket 200 surrounds an inner space 240, and the bracket 200 is provided with a top surface 210 and a bottom surface 220 which are opposite to each other. The bottom surface 220 of the bracket 200 is formed with a first opening 260, and the first opening 260 is in communication with the inner space 240 of the bracket 200. For example, the bracket 200 is shaped as a rectangular cuboid, and the bracket 200 includes the top surface 210 described above, the bottom surface 220 described above and a plurality (for example, four) of side surfaces 230. The top surface 210 and the bottom surface 220 are opposite to each other. The side surfaces 230 surrounds the top surface 210 and the bottom surface 220. Each of the side surfaces 230 is formed with a bracket windows. Thus, the top surface 210, the bottom surface 220 and the side surfaces 230 are adjoined together to jointly form the aforementioned inner space 240 therein.

The air-extraction pipe 300 is hung on the top surface 210 of the bracket 200, one part of the air-extraction pipe 300 extends into the inner space 240 of the bracket 200, and one end of the air-extraction pipe 300 is connected to a vacuum pump equipment 600 through pipelines T. The suction cup 330 is located within the inner space 240, and sleeved on one end of the air-extraction pipe 300 facing away from the vacuum pump equipment 600, that is, the suction in cup 330 is in communication with the channel of the air-extraction pipe 300, and a suction nozzle 331 of the suction cup 330 is faced towards the first opening 260.

The elastic gasket 400 includes a flexible pad 410 and a through hole 420. The flexible pad 410 is formed with a flat surface 411 and an attached surface 412 which are opposite to each other. The attached surface 412 of the flexible pad 410 is fixedly attached to the bottom surface 220 of the bracket 200. The flexible pad 410 is, for example, a rubber pad or a silicon pad, however, the disclosure is not limited thereto. The through hole 420 penetrates through the flexible pad 410 to be connected to the flat surface 411 and the attached surface 412. Furthermore, the suction nozzle 331 of the suction cup 330 is overlapped with the first opening 260 and the through hole 420, namely, the axis of the through hole 420 (e.g., the dotted line 430, FIG. 1) is coaxial with the axis of the first opening 260 (e.g., the dotted line 430, FIG. 1), and just coaxially aligned with the suction nozzle 331 of the suction cup 330.

More specifically, the top surface 210 of the bracket 200 is formed with a second opening 270, and the second opening 270 is in communication with the inner space 240 of the bracket 200. The bracket 200 is further provided with a position-limited frame 250, and the position-limited frame 250 is disposed on the top surface 210 of the bracket 200, and aligned with the second opening 270. In the embodiment, the position-limited frame 250 surrounds and forms a penetrating recess 251 that is coaxially aligned with the second opening 270 and in communication with the second opening 270.

Also, a partition space G is defined between the suction nozzle 331 of the suction cup 330 and the first opening 260, and the air-extraction pipe 300 is slidably disposed on the bracket 200 so that the suction cup 330 can be moved down by the air-extraction pipe 300 to directly contact with the bracket 200 and cover the first opening 260, or moved away from the first opening 260.

For example, the air-extraction pipe 300 includes a pipe main body which is divided into a first support arm 310 and a second support arm 320. The first support arm 310 is provided with a first air passage 313 and a first coupling portion 314. The first air passage 313 penetrates through the first support arm 310 along a long axis direction of the first support arm 310, that is, a long axis direction L of the first support arm 310 is coaxial with a long axis direction L of the first air passage 313. The second support arm 320 is disposed within the inner space 240 of the bracket 200, and the second support arm 320 is provided with a second air passage 323, a second coupling portion 324 and an insertion slot 325. The insertion slot 325 is concavely formed on one end surface 320A of the second support arm 320 facing away from the suction cup 330. The second air passage 323 penetrates through the second support arm 320 along a long axis direction of the second support arm 320, and to be connected to the insertion slot 325. The insertion slot 325 and the suction cup 330 are respectively disposed on two opposite ends of the second support arm 320, and the second coupling portion 324 is formed within the insertion slot 325. A long axis direction L of the insertion slot 325, a long axis direction L of the second support arm 320, a long axis direction L of the second air passage 323 and the long axis direction of the first support arm 310 are coaxial with each other. When the second coupling portion 324 is engaged with the first coupling portion 314, one end of the first support arm 310 is connected to one end of the second support arm 320, and the first air passage 313 is in communication with the second air passage 323.

Furthermore, the first support arm 310 includes a first tube body 311 and a second tube body 312. The first tube body 311 is disposed outside the inner space 240 and stopped by the position-limited frame 250. The second tube body 312 protrudes outwards from one end of the first tube body 311 and extends into the second opening 270 through the position-limited frame 250. A pipe diameter P2 of the second tube body 312 is less than a pipe diameter P1 of the first tube body 311. The first air passage 313 goes through the first tube body 311 and the second tube body 312 in sequence, and the first coupling portion 314 is located on the second tube body 312. For example, the first coupling portion 314 includes external threads located on the outer surface of the second tube body 312, however, the disclosure is not limited thereto.

The second support arm 320 includes a third tube body 321 and a fourth tube body 322. The third tube body 321 is disposed within the inner space 240 and connected to the second tube body 312. The fourth tube body 322 protrudes outwards from one end of the third tube body 321 and extends into the suction cup 330. A pipe diameter P4 of the fourth tube body 322 is less than a pipe diameter P3 of the third tube body 321. The second air passage 323 goes through the third tube body 321 and the fourth tube body 322 in sequence, and the second coupling portion 324 is located within the third tube body 321. For example, the second coupling portion 324 includes internal threads located in the inner surface of the insertion slot 325, however, the disclosure is not limited thereto.

Thus, in the embodiment, since the pipe diameter P1 of the first tube body 311 of the first support arm 310 is larger than a caliber A of the second opening 270, the first tube body 311 of the first support arm 310 is stopped from continuing to decline by the position-limited frame 250 of the bracket 200. Since one end surface 320A (i.e., the pipe diameter P3 of the third tube body 321) of the second support arm 320 facing away from the suction cup 330 is larger than a caliber A of the second opening 270. The third tube body 321 of the second support arm 320 is stopped from continuing to rise by the position-limited frame 250 of the bracket 200, in other words, the second tube body 312 of the first support arm 310 only can be slidably disposed within the second opening 270.

In addition, in the embodiment, the element pickup mechanism 10 further includes a stepping motor 700. The stepping motor 700 is connected to the pick-up arm 100. For example, the stepping motor 700 is connected to the bracket 200 of the pick-up arm 100 and/or the air-extraction pipe 300. Thus, the stepping motor 700 can quickly or gradually elevate the pick-up arm 100.

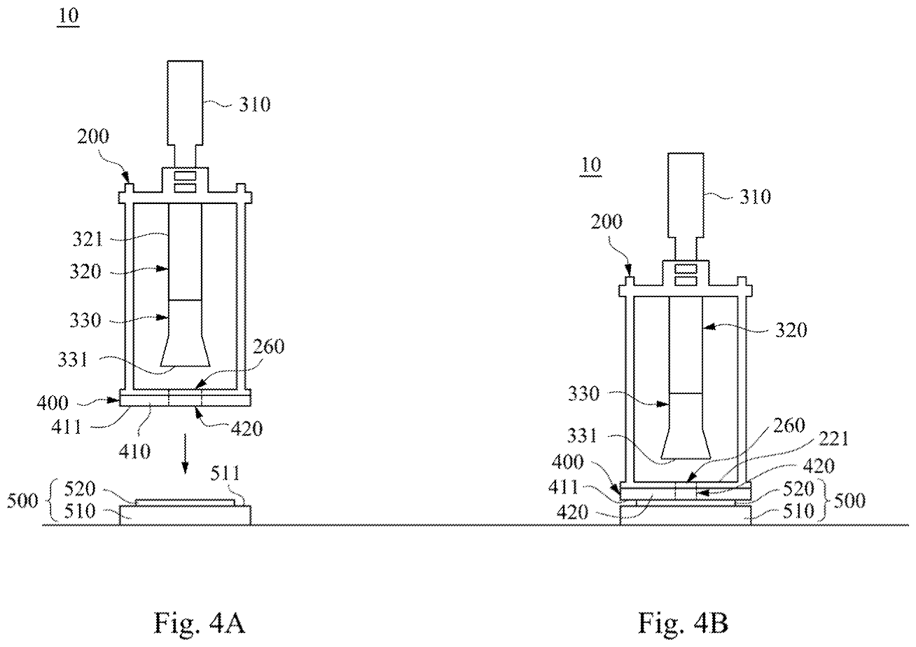

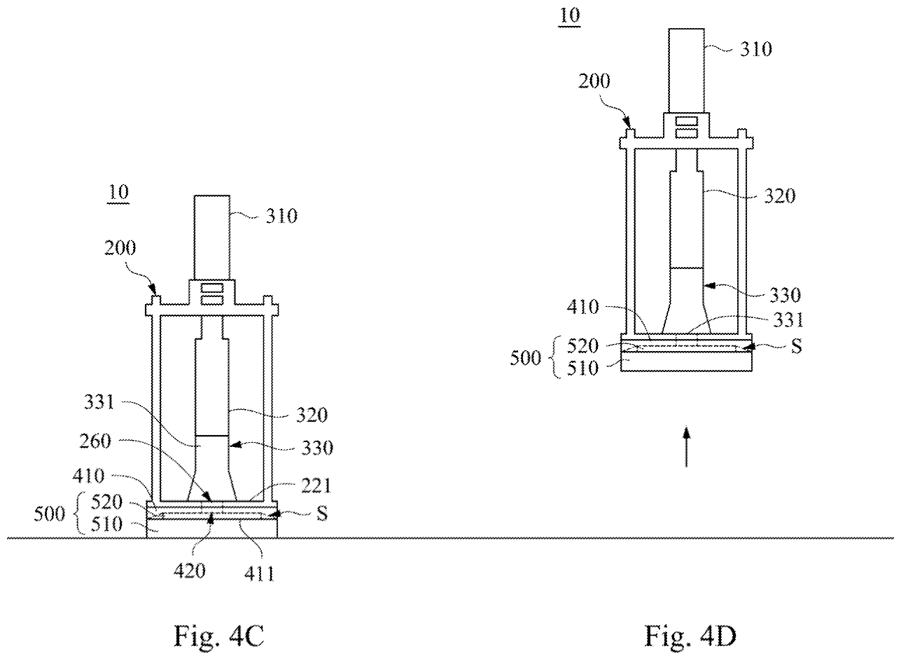

FIG. 4A to FIG. 4D are continuous operation schematic views of the element pickup mechanism 10 of FIG. 1. Thus, as shown in FIG. 4A, when a chip pickup procedure is started to be performed by the element pickup mechanism 10, the element pickup mechanism 10 is moved above a packaged chip 500 in the first place. At this moment, the bracket 200 of the element pickup mechanism 10 is suspended on the third tube body 321 of the second support arm 320, such that the suction nozzle 331 of the suction cup 330 is separated from the first opening 260. In the embodiment, the packaged chip 500 includes a chip body 510 and a coating layer 520. The coating layer 520 is formed on a top surface 511 of the chip body 510, and an area of the coating layer 520 is smaller than an area of the flat surface 411 of the flexible pad 410. The coating layer 520 is, for example a porous structure layer with porous structure thereon. For example, the coating layer 520 is an additional coating layer such as a boiling enhancement coating (BEC) layer and/or a surface treatment layer, however, the disclosure is not limited thereto, and in other embodiments, the coating layer 520 may also be a mesh structure layer.

Next, as shown in FIG. 4A and FIG. 4B, when the bracket 200 of the element pickup mechanism 10 is descended, the flat surface 411 of the flexible pad 410 directly covers the coating layer 520 of the packaged chip 500. At this moment, the suction nozzle 331 of the suction cup 330 is still separated from the first opening 260 (FIG. 4B). Therefore, since the suction nozzle 331 of the suction cup 330 has not yet descended to an inner bottom wall 221 of the bracket 200, an operator may still make fine adjustments to the position or state of the packaged chip 500 at this stage, thereby not needed to pull the bracket 200 up again.

Next, as shown in FIG. 4B and FIG. 4C, when suction nozzle 331 of the suction cup 330 is descended so as to press the inner bottom wall 221 of the bracket 200 and completely cover the first opening 260, since the flat surface 411 of the flexible pad 410 directly covers the chip body 510 and the coating layer 520, an enclosed space S is jointly defined between the suction cup 330, the flexible pad 410 and the packaged chip 500, and the coating layer 520 is completely located in the enclosed space S.

Thus, since the coating layer 520 is completely located in the closed space S, the porous structure of the coating layer 520 cannot be in communication with external connection, thus, the vacuum pump equipment 600 (FIG. 1) can start to provide vacuum suction, that is, air flow between the flexible pad 410 and the packaged chip 500 starts to return the vacuum pump equipment 600 (FIG. 1) through the through hole 420, the first opening 260 and the air-extraction pipe 300 in sequence, such that the air-extraction pipe 300 sucks the packaged chip 500 onto the flexible pad 410 by vacuum pumping through the through hole 420.

In addition, as shown in FIG. 4B, the air-extraction pipe 300 is driven by the stepping motor 700 to be gradually moved to the first opening 260, thereby, avoid from falling directly to punch the inner bottom wall 221 of the bracket 200.

Next, as shown in FIG. 4C and FIG. 4D, finally, when the element pickup mechanism 10 is ascended, since the packaged chip 500 is effectively vacuum-adsorbed onto the flexible pad 410, the packaged chip 500 can be picked up along with the pick-up arm 100 to complete the chip pickup procedure.

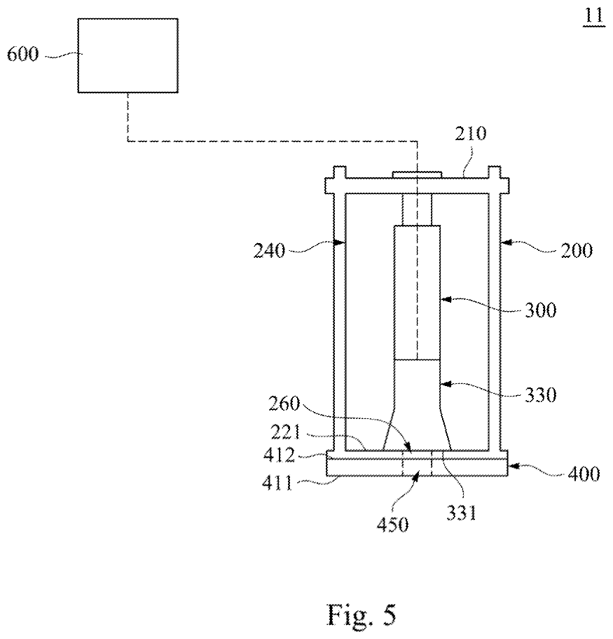

FIG. 5 is a schematic view of an element pickup mechanism 11 according to one embodiment of the present disclosure. As shown in FIG. 5, the element pickup mechanism 11 of the embodiment and the element pickup mechanism 10 of FIG. 1 are substantially the same, except that the air-extraction pipe 300 is fixed on the bracket 200 rather than being movably installed on the bracket 200. Thus, the air-extraction pipe 300 is fixed within the inner space 240 of the bracket 200, and the air-extraction pipe 300 is fixedly screwed on the top surface 210 of the bracket 200. The suction nozzle 331 of the suction cup 330 continuously contacts with the inner bottom wall 221 of the bracket 200, directly covers the first opening 260, and connected to the through hole 420 through the first opening 260.

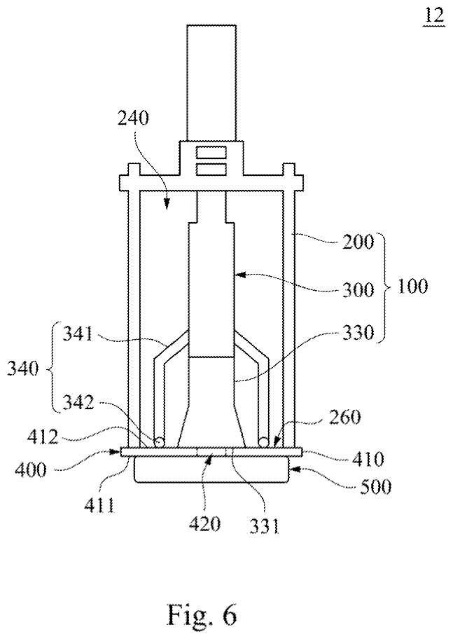

FIG. 6 is a schematic view of an element pickup mechanism 12 according to one embodiment of the present disclosure. As shown in FIG. 6, the element pickup mechanism 12 of the embodiment and the one of FIG. 1 are substantially the same, except that the bracket 200 is provided in the absence of the above-mentioned bottom surface and the above-mentioned inner bottom wall thereof, that is, the entire of the bottom surface of the bracket 200 is replaced by a first opening 260, so that the inner space 240 of the bracket 200 is directly connected to the attached surface 412 and the through hole 420 of the flexible pad 410.

In addition, the pick-up arm 100 further includes one or more supporting shafts 340. The supporting shafts 340 are symmetrically connected to the long sides of the air-extraction pipe 300 (e.g., pipe main body) and abutted against the flexible pad 410. More specifically, each of the supporting shaft includes an extending rib 341 and an abutment portion 342. The extending rib 341 reaches the flexible pad 410 from the long side of the air-extraction pipe 300. The abutment portion 342 is located at one end of the extending rib 341 to abut against the attached surface 412 of the flexible pad 410 for directly abutting against the attached surface 412 of the flexible pad 410, so as to disperse and uniformize the pressure under the air-extraction pipe 300, which helps to maintain the above-mentioned closed space S. For example, the abutment portion 342 is spherical or tubular to reduce the risk of the flexible pad 410 being injured.

Thus, when the flexible pad 410 is driven down to the packaged chip 500, and the suction nozzle 331 of the suction cup 330 directly contacts and covers the through hole 420 of the flexible pad 410,
since the suction nozzle 331 of the suction cup 330 and the abutment portion 342 of the supporting shafts 340 respectively abut against the flexible pad 410 symmetrically, the flexible pad 410 can be more stably clamped between the packaged chip 500 and the pick-up arm 100, thereby more stably improving the above-mentioned vacuum adsorption.

Thus, through the construction of the embodiments above, the disclosure is able to improve the success rate of vacuum adsorption on packaged chips, thereby reducing the risks that suction failure to the semiconductor packaged chip or falling damage during transportation.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. An element pickup mechanism, comprising:
a pick-up arm comprising:
a bracket that is provided with an inner space and a first opening formed on one side of the bracket and being in communication with the inner space;
an air-extraction pipe that is disposed on the bracket and used to connect to a vacuum pump equipment; and
a suction cup that is sleeved on one end of the air-extraction pipe, located in the inner space and facing towards the first opening of the bracket;
an elastic gasket comprising:
a flexible pad formed with a flat surface and an attached surface which are opposite to each other, the attached surface is fixedly attached to the one side of the bracket; and
a through hole penetrating through the flexible pad to coaxially align with the first opening and the suction cup,
wherein when the flat surface of the flexible pad directly covers a packaged chip and a suction nozzle of the suction cup covers the first opening, the air-extraction pipe sucks the packaged chip onto the flexible pad by vacuum pumping through the through hole.

2. The element pickup mechanism of claim 1, wherein a partition space is formed between the suction nozzle and the first opening, and the air-extraction pipe is slidably disposed on the bracket so that the suction nozzle can be moved to directly contact with the bracket and cover the first opening by the air-extraction pipe.

3. The element pickup mechanism of claim 2, wherein the air-extraction pipe comprises:
a first support arm that is provided with a first air passage and a first coupling portion, the first air passage penetrating through the first support arm, and a long axis direction of the first support arm that is coaxial with a long axis direction of the first air passage; and
a second support arm that is disposed within the inner space, provided with a second air passage and a second coupling portion, the second air passage penetrating through the second support arm, and a long axis direction of the second support arm, a long axis direction of the second air passage and the long axis direction of the first support arm being coaxial with each other,
wherein when the second coupling portion is engaged with the first coupling portion, one end of the first support arm is connected to one end of the second support arm, and the first air passage is in communication with the second air passage.

4. The element pickup mechanism of claim 3, wherein the bracket is further provided with a second opening and a position-limited frame, the second opening is formed on another side of the bracket and in communication with the inner space, and the position-limited frame is disposed on the another side of the bracket and aligned with the second opening;
the first support arm comprises a first tube body and a second tube body, the first tube body is disposed outside the inner space and stopped by the position-limited frame, and the second tube body protrudes outwards from one end of the first tube body and extends into the second opening through the position-limited frame, wherein a pipe diameter of the second tube body is less than a pipe diameter of the first tube body, the first air passage goes through the first tube body and the second tube body in sequence, and the first coupling portion is located on the second tube body; and
the second coupling portion and the suction cup are respectively located at two opposite ends of the second support arm, and one end surface of one of the two opposite ends of the second support arm facing away from the suction cup is larger than a caliber of the second opening.

5. The element pickup mechanism of claim 4, wherein the second coupling portion comprises internal threads that are formed in the second support arm; and
the first coupling portion comprises external threads that are formed on an outer surface of the second tube body for being engaged with the external threads.

6. The element pickup mechanism of claim 1, further comprising:
a stepping motor that is connected to the pick-up arm and used for elevating the pick-up arm.

7. The element pickup mechanism of claim 1, wherein the air-extraction pipe is fixed on the bracket, so that the suction nozzle of the suction cup is fixedly contacted with the bracket to directly cover the first opening.

8. The element pickup mechanism of claim 1, wherein a top surface of the packaged chip is provided with a coating layer, and an area of the coating layer is smaller than an area of the flat surface of the flexible pad, and the coating layer is one of a porous structure layer and a mesh structure layer,
wherein when the flat surface of the flexible pad directly covers the top surface of the packaged chip and the coating layer, an enclosed space is jointly defined between the suction cup, the flexible pad and the packaged chip, and the coating layer is completely located in the enclosed space.

9. The element pickup mechanism of claim 1, wherein the pick-up arm further comprises:
at least one supporting shaft that is connected to the air-extraction pipe and abutting against the flexible pad.

10. The element pickup mechanism of claim 9, wherein the supporting shaft comprises:
an extending rib reaching the flexible pad from the air-extraction pipe; and
an abutment portion located at one end of the extending rib to abut against the attached surface of the flexible pad.

11. An element pickup mechanism, comprising:
a flexible pad having a first surface and a second surface which are opposite to each other, the flexible pad that is formed with a through hole penetrating through the flexible pad to be connected to the first surface and the second surface, and the first surface that is used to press a packaged chip;
a bracket that is connected to the second surface of the flexible pad; and
an air-extraction pipe comprising a pipe main body and a suction cup, the pipe main body that is liftably passed through the bracket, and one end of the pipe main body that is connected to a vacuum pump equipment, and another end of the pipe main body that is sleeved on the suction cup, and an inner portion of the pipe main body being in communication with the through hole through the suction cup, so that the vacuum pump equipment is able to vacuum-adsorbed the packaged chip onto the flexible pad through the air-extraction pipe and the through hole.

12. The element pickup mechanism of claim 11, wherein the bracket is provided with an inner space and a first opening formed on one side of the bracket and being in communication with the inner space, the pipe main body and the suction cup are received within the inner space, and a suction nozzle of the suction cup faces towards the first opening, wherein the through hole, the first opening and the suction nozzle of the suction cup are coaxially aligned.

13. The element pickup mechanism of claim 12, wherein a partition space is formed between the suction nozzle and the first opening, and the air-extraction pipe is slidably disposed on the bracket so that the suction nozzle can be moved to directly contact with the bracket and cover the first opening by the air-extraction pipe.

14. The element pickup mechanism of claim 12, wherein the pipe main body comprises:
a first support arm that is provided with a first air passage and a first coupling portion, the first air passage penetrating through the first support arm, and a long axis direction of the first support arm is coaxial with a long axis direction of the first air passage; and
a second support arm that is disposed within the inner space, provided with a second air passage and a second coupling portion, the second air passage penetrating through the second support arm, and a long axis direction of the second support arm, a long axis direction of the second air passage and the long axis direction of the first support arm being coaxial with each other,
wherein when the second coupling portion is engaged with the first coupling portion, one end of the first support arm is connected to one end of the second support arm, and the first air passage is in communication with the second air passage.

15. The element pickup mechanism of claim 14, wherein the bracket is further provided with a position-limited frame and a second opening, the second opening is formed on another side of the bracket and in communication with the inner space, and the position-limited frame is disposed on the another side of the bracket and aligned with the second opening;
the first support arm comprises a first tube body and a second tube body, the first tube body is disposed outside the inner space and stopped by the position-limited frame, and the second tube body protrudes outwards from one end of the first tube body and extends into the second opening through the position-limited frame, wherein a pipe diameter of the second tube body is less than a pipe diameter of the first tube body, and the first air passage goes through the first tube body and the second tube body in sequence, and the first coupling portion is located with the second tube body; and
the second coupling portion and the suction cup are respectively located at two opposite ends of the second support arm, and one end surface of one of the two opposite ends of the second support arm facing away from the suction cup is larger than a diameter of the second opening.

16. The element pickup mechanism of claim 15, wherein the second coupling portion comprises internal threads that are formed in the second support arm; and
the first coupling portion comprises external threads that are formed on an outer surface of the second tube body for being engaged with the external threads.

17. The element pickup mechanism of claim 11, further comprising:
a stepping motor that is connected to the air-extraction pipe for elevating the air-extraction pipe.

18. The element pickup mechanism of claim 11, wherein a top surface of the packaged chip is provided with a coating layer having an area being smaller than an area of the first surface of the flexible pad, and the coating layer is one of a porous structure layer and a mesh structure layer,
wherein when the first surface of the flexible pad directly covers the top surface of the packaged chip and the coating layer, an enclosed space is jointly defined between the suction cup, the flexible pad and the packaged chip, and the coating layer is completely located in the enclosed space.

19. The element pickup mechanism of claim 11, wherein the air-extraction pipe further comprises:
at least one supporting shaft that is connected to the pipe main body and abutting against the flexible pad.

20. The element pickup mechanism of claim 19, wherein the supporting shaft comprises:
an extending rib reaching the flexible pad from the pipe main body; and
an abutment portion located at one end of the extending rib to abut against the second surface of the flexible pad.
